(19) United States
(12) Patent Application Publication
(10) Pub. No.: US 2026/0249335 A1
(43) Pub. Date: Aug. 27, 2026

(54) FOOD WASTE PROCESSOR

(71) Applicant: CeresCycle, Inc., Arvada, CO (US)

(72) Inventor: Peter Doo, Arvada, CO (US)

(21) Appl. No.: 19/548,767

(22) Filed: Feb. 24, 2026

Related U.S. Application Data
(60) Provisional application No. 63/762,584, filed on Feb. 24, 2025.

(51) Int. Cl. B09B 3/35; B09B 3/40; B09B 101/70

(52) U.S. Cl. CPC B09B 3/35; B09B 3/40; B09B 2101/70

(57) ABSTRACT

An apparatus is described comprising a drawer component including a food waste processor, wherein the food waste processor comprises a bucket, at least one heating element, and a fan, wherein the bucket comprises at least one grinder paddle, the drawer component configured to removably secure the waste receptacle within a cabinet, wherein the secured waste processor positions the bucket in a sealed chamber, wherein the sealed chamber is in fluid communication with a filter, and the bucket, the at least one grinder, the at least one heating element, and the fan of the secured waste receptacle configured to cooperatively process food waste in a processing cycle.

### RELATED APPLICATIONS

This application claims the benefit of U.S. Application No. 63/762,584, filed Feb. 24, 2025.

### TECHNICAL FIELD

The disclosure herein involves food waste processors under an embodiment.

### BACKGROUND

A food waste processor (or recycler/electric composter) is a kitchen appliance that dries, grinds, and reduces the volume of food scraps by 80-90% in 3-5 hours, turning waste into dry, odorless, nutrient-rich, soil-amendment “grounds”.

### Incorporation by Reference

Each patent, patent application, and/or publication mentioned in this specification is herein incorporated by reference in its entirety to the same extent as if each individual patent, patent application, and/or publication was specifically and individually indicated to be incorporated by reference.

### SUMMARY OF THE INVENTION

An apparatus is described herein comprising under an embodiment a drawer component including a food waste processor, wherein the food waste processor comprises a bucket, at least one heating element, and a fan, wherein the bucket comprises at least one grinder paddle, the drawer component configured to removably secure the waste receptacle within a cabinet, wherein the secured waste processor positions the bucket in a sealed chamber, wherein the sealed chamber is in fluid communication with a filter, and the bucket, the at least one grinder, the at least one heating element, and the fan of the secured waste receptacle configured to cooperatively process food waste in a processing cycle.

In embodiments, the at least one heating element is located underneath a bottom surface of the bucket.

In embodiments, the heating elements is integrally formed within the bottom surface of the bucket.

In embodiments, the securing the waste receptacle within the cabinet couples the at least one grinder paddle, the at least one heating element, and the fan to a power source.

In embodiments, the removal of the waste receptacle from the cabinet decouples the at least one grinder paddle, the heating element, and the fan from the power source.

In embodiments, the fan is configured to draw air from the bucket and into the filter.

In embodiments, the fan is configured to draw air from the filter into a fluid communications pathway.

In embodiments, the fluid communications pathway comprises a tube.

In embodiments, the fluid communications pathway directs flow of the air around a side of the bucket within the sealed chamber.

In embodiments, the fluid communication pathway directs flow of the air out a manifold located in a forward facing side of the drawer component.

In embodiments, the processing cycle comprises activating the at least one heating element to heat the food waste.

In embodiments, the activated at least one heating element generates a temperature of 160 degrees to 212 degrees Fahrenheit within the receptacle.

In embodiments, the processing cycle comprises activation of the at least one grinder paddle.

In embodiments, the bucket is removably secured within the food waste processor.

In embodiments, the filter comprises a charcoal filter.

In embodiments, the processing cycle comprises a duration of at least one hour.

### BRIEF DESCRIPTION OF THE DRAWINGS

FIG. 1 shows a food waste processor drawer configuration, under an embodiment.

FIG. 2 shows an installed food waste processor drawer configuration, under an embodiment.

FIG. 3 shows an installed food waste processor drawer configuration, under an embodiment.

FIG. 4 shows a food waste processor drawer configuration in an open state, under an embodiment.

FIG. 5 shows a cross-sectional perspective view of a food waste processor drawer, under an embodiment.

FIG. 6 shows a side cross-sectional schematic view of a food waste processor drawer, under an embodiment.

FIG. 7 shows a top cross-sectional schematic view of a food waste processor drawer, under an embodiment.

FIG. 8A shows a schematic food waste processor drawer configuration, under an embodiment.

FIG. 8B shows control systems of a food waste processor drawer configuration, under an embodiment.

FIG. 9A shows a front schematic view of food waste processor drawer configuration, under an embodiment

FIG. 9B shows a front schematic view of food waste processor drawer configuration, under an embodiment

FIG. 10A shows a top view of a bucket, under an embodiment.

FIG. 10B shows a top view of a bucket, under an embodiment

FIG. 11 shows a top view of a bucket, under an embodiment.

FIG. 12 shows an installed waste processor drawer configuration, under an embodiment.

### DETAILED DESCRIPTION

The Ceres residential food waste processor is an evolution of the countertop versions of this device. Ceres comprises a drawer configuration, under an embodiment. Aesthetically, the only part of the processor that is visible is the front panel. Ceres' standard finish is stainless steel to match the classic and most popular appliance finish in America. The panel is also customizable to match the kitchen cabinetry.

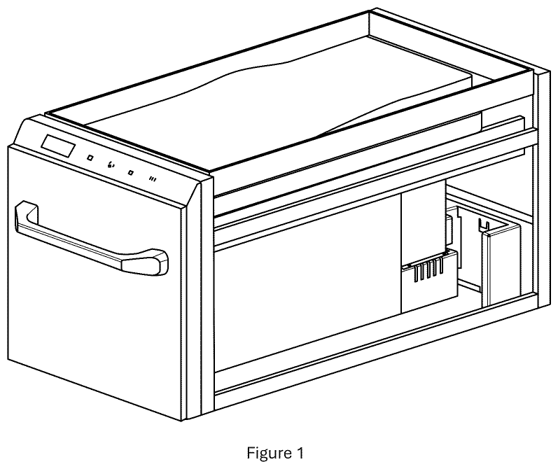

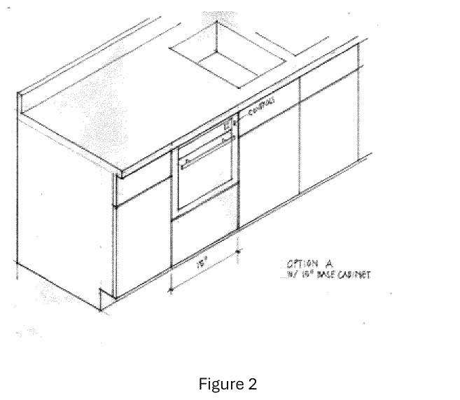

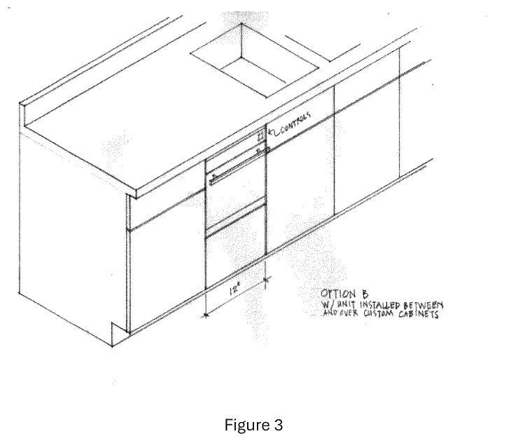

Technically, there are several design features that set Ceres apart from other devices performing the same function. Foremost is its drawer configuration (FIG. 1). This is unique and removes the appliance from the countertop or floor where space is so precious. Ceres is only 12″ wide to integrate into the modular design of kitchen cabinets. It can be installed within a 15″ custom cabinet (FIG. 2) or simply in a 12″ space between adjacent base cabinet units (FIG. 3). The space below allows for a drawer that can be used to store anything the resident may need in the kitchen.

### Function

Functionally, Ceres grinds and dehydrates food waste into a dirt-like product reducing the food waste volume by as much as 85%. This material is called Ceres Soil which is easier to manage due to its smaller volume, dry composition, and lack of odor. Biologically, this material is not compost but it retains its organic nature and is more easily composted than raw food waste. The receptacle (or bucket) has an eight-liter capacity enabling it to handle food waste from a family of four for up to a week. The bucket is removable by use of a concealed handle enabling it to be easily emptied when full. Ideally, the waste material would be disposed of through a municipal or private composting program.

### Operations

With the drawer open during food prep or clean up, the receptacle is available from either side of the device. Food waste can be scraped into the bin directly from cutting boards or from plates after the meal. When ready, the operator simply closes the drawer and pushes the start button. When the cycle begins, the rotors start to agitate and grind the food while heaters bring the temperature of the container to somewhere between 160° to 212°. A cycle is about 5 hours but embodiments are not so limited.

When the cycle starts, the drawer locks. If the operator wants to add food scraps in the middle of the cycle, s/he simply turns the device off, opens the drawer, adds the material, closes the drawer, and restarts the machine.

### Safety

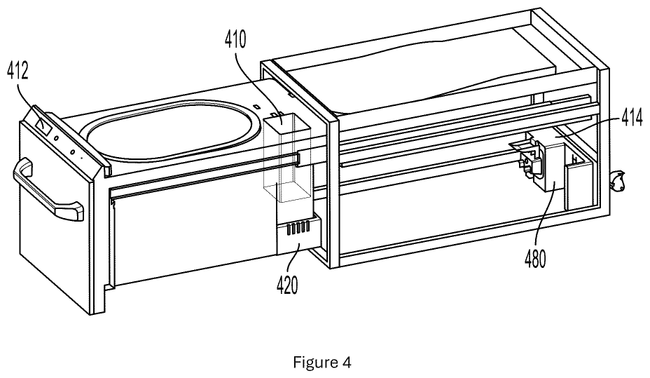

The drawer disconnects from power when it is open (FIG. 4). This ensures that the heater and rotors are off so hands are not at risk and large pieces of food, accidentally dropped into the bucket, cannot jamb the device. There will be a “hot” indicator light to inform users that the device is still hot if it has been opened mid-cycle or if it has just completed a cycle. Note that the power block shown in FIG. 4 shows a recess 480 which accommodates the charcoal filter and fan 410. Insertion of the waste processor couples the power source 414 to the to the waste processor components, i.e. the grinder paddles, the heating element, and the fan 420 to the power source (all such elements are further described below). Note that the waste processor drawer configuration maintains power to the control panel in an open or closed/operational state.

### Ventilation

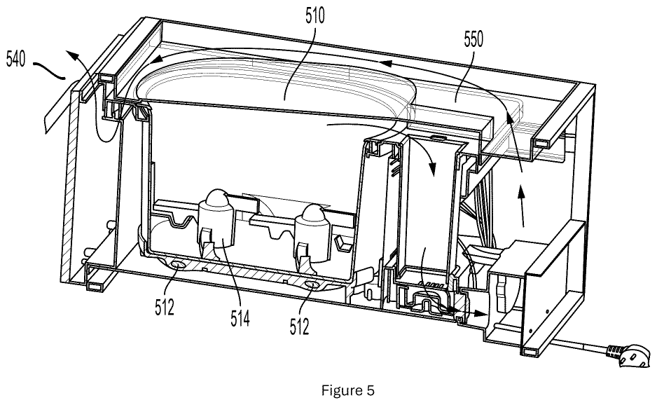

Because the only exposed part of Ceres is its front panel, exhaust air must flow out of the front panel. Ventilation flows through the top of the waste receptacle through a rechargeable charcoal filter to remove odors, then around the sides of the bucket to an exhaust port in the face of the panel. FIG. 5 shows the pathway of air through the filter, passing through the fan, and directed around the perimeter of the bucket and out an exhaust in the front panel.

FIG. 5. shows a cross sectional perspective view of the food waste processor drawer, under an embodiment. FIG. 5 shows the receptacle 510 including grinder paddles 514. FIG. 5 shows location of the filter 520 and the fan 518. FIG. 5 also shows heating elements 512 located directly beneath the receptacle 510 and grinder paddles 514. Under an alternative embodiment, heating elements may be integrally formed with the bottom layer of the receptacle.

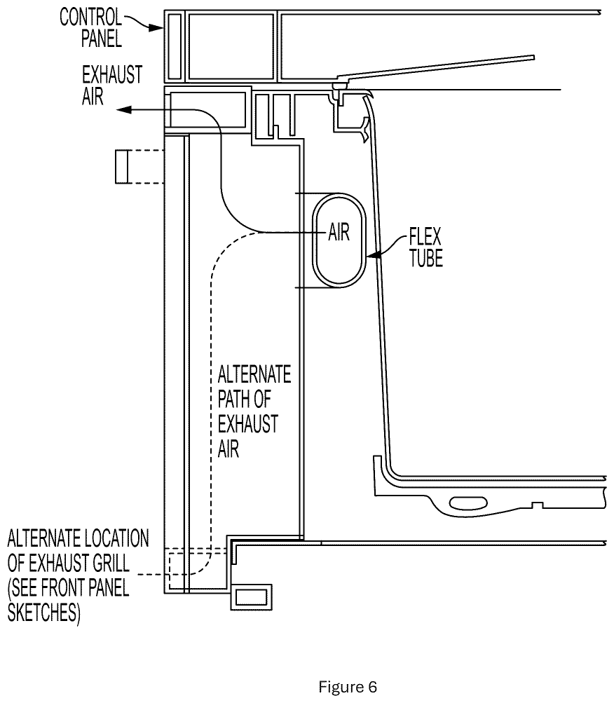

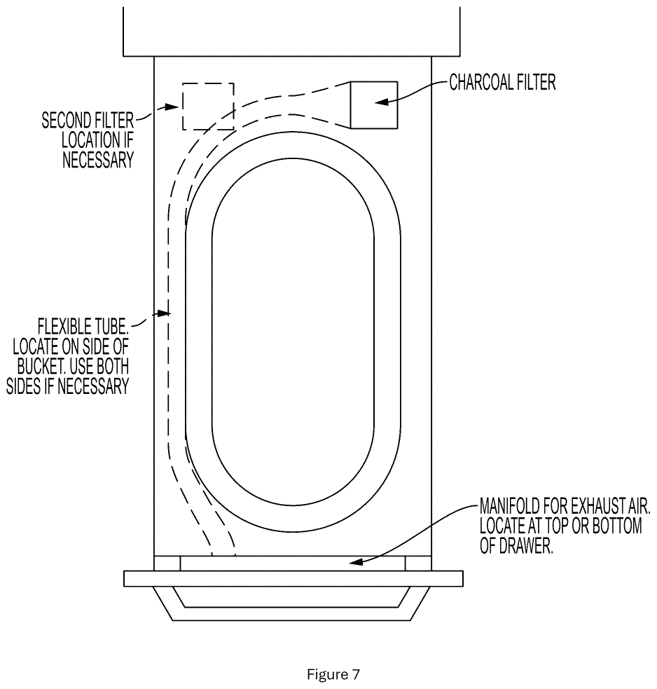

The exhaust port may be located at the top or bottom of the drawer face (FIG. 6). The white The bucket is sealed in a chamber (FIGS. 5, 550) when the drawer is closed. Air is directed by the contours of the panel above the bucket directly into the filter chamber. Air is drawn by a fan located at the base of the filter box. After passing through the fan, air enters a hose (FIG. 6 and FIGS. 7, 610 that is threaded along the side of the bucket to the front of the appliance where it connects to an exhaust port. The fan draws the air into the filter then pushes it along to the exhaust port.

FIG. 7 shows pathway of flexible tube 610 along the side of the bucket, under an embodiment. The tube leads to a manifold for exhaust air located at the top or bottom of the drawer. A fixed heating element is located below, but not a part of, the bucket. It provides a “saddle” for the bucket so it is properly positioned and heat is evenly distributed. This device grinds and dehydrates the food waste. The product it produces is not compost but might be considered pre-compost. Pretreated material composts more quickly than raw food waste.

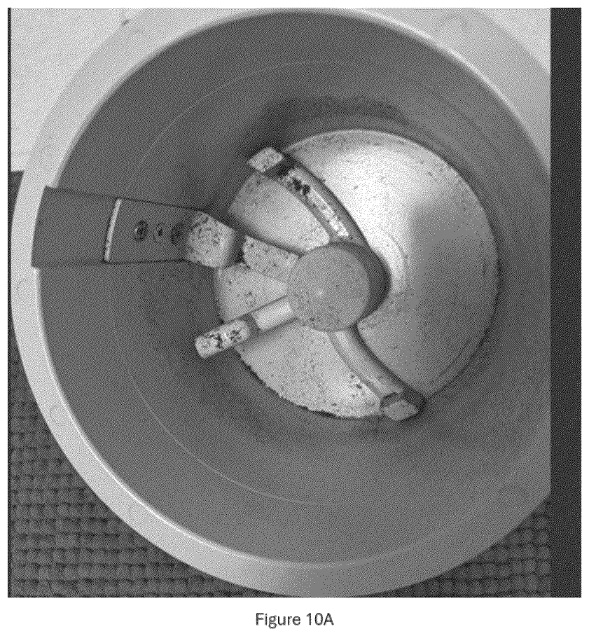

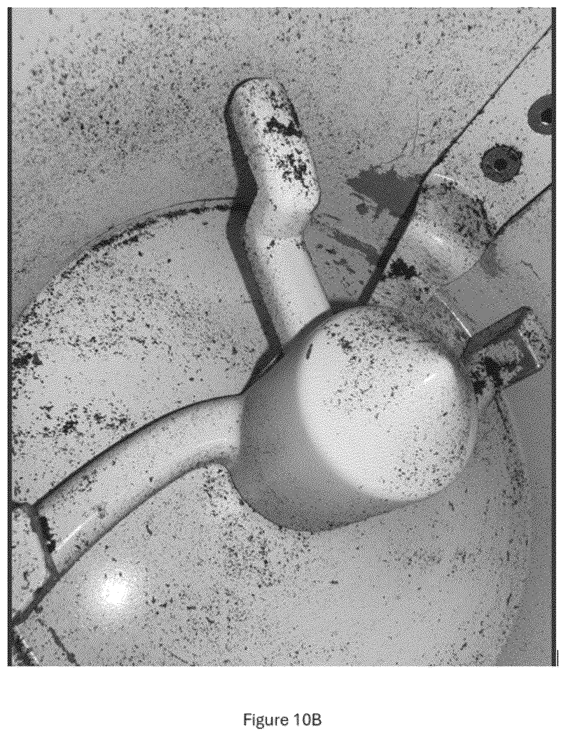

FIGS. 5, 10A, and 10B show configurations of the grinder paddles under embodiments. This geometry works well to ensure that all food waste is ground, and no large chunks remain.

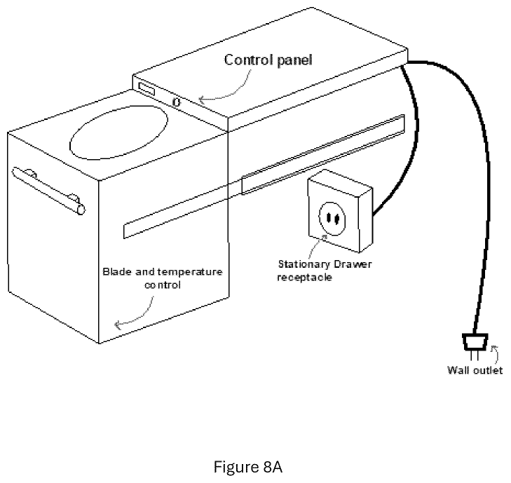

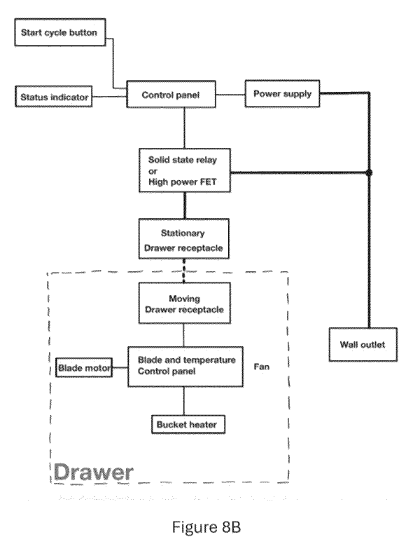

FIG. 8B shows flow of electrical power to control panel which then manages electrical couplings with components of the waste processor. As shown in FIGS. 8A and 8B, power flows from the control panel to the drawer receptacle. When the drawer is opened, the grinders, heating element, and ventilation fan disconnect but the control panel remains powered. Under and embodiment, the control panel is a part of the cabinet and is stationary. All of the ventilation system; filter, fan, tubing and exhaust port, is a part of the drawer and travels with the drawer and disconnects whenever the drawer is open.

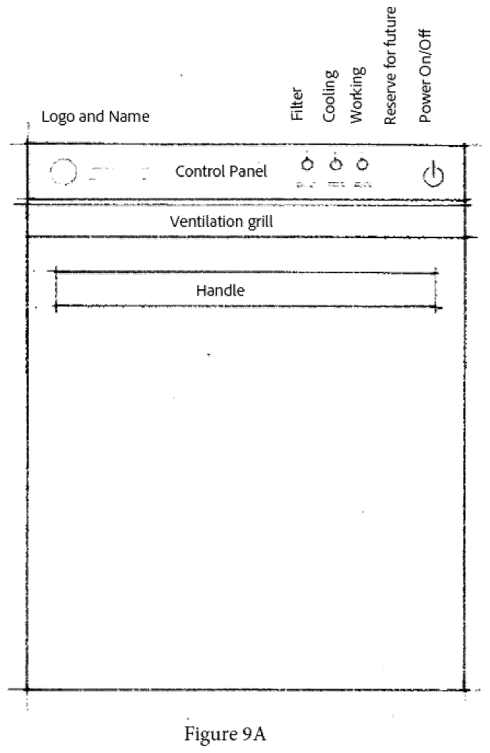

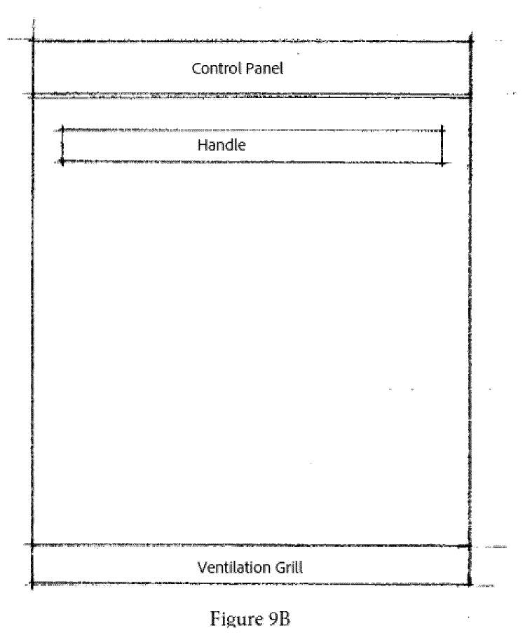

FIG. 9A shows a configuration of the waste processor front panel, under an embodiment. FIG. 9B shows a configuration of the waste processor front panel, under an embodiment. FIGS. 10A and 10B shows examples of grinder paddles, under an embodiment.

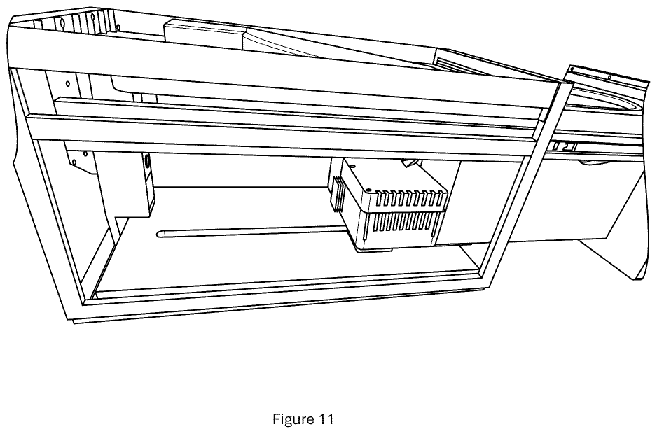

FIG. 11 shows a top view of a bucket, under an embodiment.

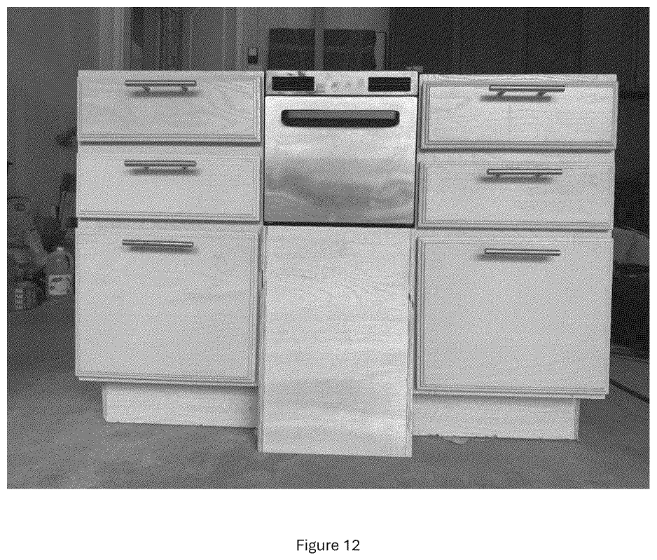

FIG. 12 shows an installed waste processor drawer configuration, under an embodiment.

1. An apparatus comprising,
a drawer component including a food waste processor, wherein the food waste processor comprises a bucket, at least one heating element, and a fan, wherein the bucket comprises at least one grinder paddle;
the drawer component configured to removably secure the waste receptacle within a cabinet, wherein the secured waste processor positions the bucket in a sealed chamber, wherein the sealed chamber is in fluid communication with a filter;
the bucket, the at least one grinder, the at least one heating element, and the fan of the secured waste receptacle configured to cooperatively process food waste in a processing cycle.

2. The apparatus of claim 1, wherein the at least one heating element is located underneath a bottom surface of the bucket.

3. The apparatus of claim 1, wherein the heating elements is integrally formed within the bottom surface of the bucket.

4. The apparatus of claim 1, wherein the securing the waste receptacle within the cabinet couples the at least one grinder paddle, the at least one heating element, and the fan to a power source.

5. The apparatus of claim 4, wherein the removal of the waste receptacle from the cabinet decouples the at least one grinder paddle, the heating element, and the fan from the power source.

6. The apparatus of claim 5, wherein the fan is configured to draw air from the bucket and into the filter.

7. The apparatus of claim 6, wherein the fan is configured to draw air from the filter into a fluid communications pathway.

8. The apparatus of claim 7, wherein the fluid communications pathway comprises a tube.

9. The apparatus of claim 8, wherein the fluid communications pathway directs flow of the air around a side of the bucket within the sealed chamber.

10. The apparatus of claim 9, wherein the fluid communication pathway directs flow of the air out a manifold located in a forward facing side of the drawer component.

11. The apparatus of claim 1, wherein the processing cycle comprises activating the at least one heating element to heat the food waste.

12. The apparatus of claim 11, wherein the activated at least one heating element generates a temperature of 160 degrees to 212 degrees Fahrenheit within the receptacle.

13. The apparatus of claim 12, wherein the processing cycle comprises activation of the at least one grinder paddle.

14. The apparatus of claim 13, wherein the bucket is removably secured within the food waste processor.

15. The apparatus of claim 14, wherein the filter comprises a charcoal filter.

16. The apparatus of claim 1, wherein the processing cycle comprises a duration of at least one hour.
